(19) United States
(12) Patent Application Publication
(10) Pub. No.: US 2019/0296393 A1
(43) Pub. Date: Sep. 26, 2019

(54) SULFIDE SOLID-STATE BATTERY

(71) Applicant: Toyota Jidosha Kabushiki Kaisha, Toyota-shi (JP)

(72) Inventor: Masaki WATANABE, Sunto-gun (JP)

(73) Assignee: Toyota Jidosha Kabushiki Kaisha, Toyota-shi (JP)

(21) Appl. No.: 16/353,175

(22) Filed: Mar. 14, 2019

(30) Foreign Application Priority Data
Mar. 22, 2018 (JP) 2018-055032

(51) Int. Cl. H01M 10/0562; H01M 10/0585

(52) U.S. Cl. CPC H01M 10/0562; H01M 2300/0091; H01M 2300/0068; H01M 10/0585

(57) ABSTRACT

In a solid electrolyte layer of a sulfide solid-state battery, when the content of binder is increased in order to improve crack resistance, ion conductivity of the solid electrolyte layer lowers. Thus, provided is a sulfide solid-state battery including: a cathode, an anode, and a solid electrolyte layer provided between the cathode and the anode, the solid electrolyte layer containing a sulfide solid electrolyte, at least one binder selected from a fluorine-based binder and a rubber-based hinder, and ethyl cellulose. Incorporating ethyl cellulose along with the sulfide solid electrolyte and a predetermined binder into the solid electrolyte layer improves dispersiveness of the binder in the solid electrolyte layer, which improves crack resistance and ion conductivity of the solid electrolyte layer.

### FIELD

The present application discloses a sulfide solid-state battery.

### BACKGROUND

A sulfide solid-state battery using a sulfide solid electrolyte is known as disclosed in Patent Literatures 1 to 3. A sulfide solid-state battery includes a cathode, an anode, and a solid electrolyte layer provided between the cathode and the anode. As disclosed in Patent Literatures 1 to 3, binder may be contained in the solid electrolyte layer together with the sulfide solid electrolyte.

### CITATION LIST

### Patent Literature

Patent Literature 1: JP 2011-134675 A

Patent Literature 2: WO 2017/213156 A1

Patent Literature 3: JP 2016-039128 A

### SUMMARY

### Technical Problem

When a slim sulfide solid-state battery having wide dimensions is produced, or when a cathode/anode ununiformly expands when a sulfide solid-state battery is charged or discharged, a solid electrolyte layer undergoes stress such as compression and tension, which easily causes cracks in the solid electrolyte layer. In order to improve crack resistance of the solid electrolyte layer, it is effective to increase the content of binder in the solid electrolyte layer. However, higher content of binder in the solid electrolyte layer leads to lower ion conductivity of the solid electrolyte layer, which is problematic.

### Solution to Problem

The present application discloses, as one means for solving the problem, a sulfide solid-state battery comprising: a cathode, an anode, and a solid electrolyte layer provided between the cathode and the anode, the solid electrolyte layer containing a sulfide solid electrolyte, at least one binder selected from a fluorine-based binder and a rubber-based binder, and ethyl cellulose.

In the solid electrolyte layer of the sulfide solid-state battery of the present disclosure, a volume of the ethyl cellulose is preferably the same as or smaller than a volume of the binder.

In the sulfide solid-state battery of the present disclosure, the solid electrolyte layer preferably contains 0.1 vol % to 5 vol % of the ethyl cellulose.

In the sulfide solid-state battery of the present disclosure, the solid electrolyte layer preferably contains 0.1 vol % to 1 vol % of the ethyl cellulose.

In the sulfide solid-state battery of the present disclosure, preferably, the solid electrolyte layer contains the fluorine-based binder as the binder, and an average value of circle equivalent diameters of the fluorine-based binder is smaller than 0.2 μm, the average value being obtained by a cross-sectional image of the solid electrolyte layer.

### Advantageous Effects

According to new findings of this inventor, adding ethyl cellulose along with binder into a solid electrolyte layer of a sulfide solid-state battery improves dispersiveness of the binder in the solid electrolyte layer, which improves crack resistance and ion conductivity of the solid electrolyte layer.

### BRIEF DESCRIPTION OF DRAWINGS

FIG. 1 is an explanatory schematic view of structure of a sulfide solid-state battery 100;

FIG. 2 is an explanatory flowchart of a method for producing a sulfide solid-state battery S10;

FIG. 3 shows the minimum bend radii (crack resistance) and ion conductivity of solid electrolyte layers according to Comparative Examples 1 to 3;

FIG. 4 shows the results of the minimum bend radii (crack resistance) and ion conductivity of solid electrolyte layers according to Examples 1 to 4 and Comparative Example 2;

FIGS. 5A to 5F show cross-sectional SEM images of the solid electrolyte layers according to Example 2 and Comparative Example 2; and

FIG. 6 shows the results of the minimum bend radii (crack resistance) and ion conductivity of solid electrolyte layers according to Example 5 and Comparative Example 5.

### DETAILED DESCRIPTION OF EMBODIMENTS

1. Sulfide Solid-State Battery

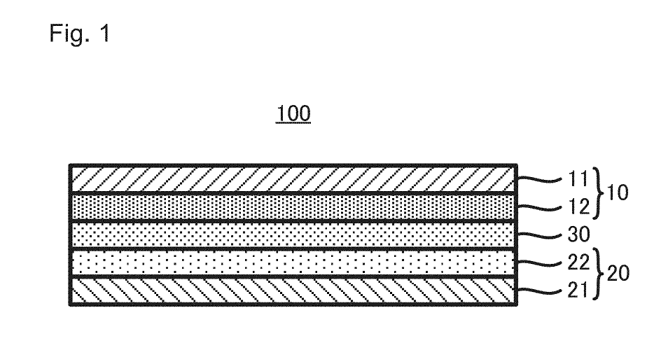

FIG. 1 schematically shows the structure of a sulfide solid-state battery 100. The sulfide solid-state battery 100 comprises a cathode 10, an anode 20, and a solid electrolyte layer 30 provided between the cathode 10 and the anode 20. The solid

electrolyte layer 30 contains a sulfide solid electrolyte, at least one binder selected from a fluorine-based binder and a rubber-based binder, and ethyl cellulose.

1.1. Cathode 10

The structure of the cathode 10 in the sulfide solid-state battery 100 is obvious for the person skilled in the art, and hereinafter one example thereof will be described.

The cathode 10 usually includes a cathode mixture layer 12 that contains a cathode active material, and as optional constituents, a solid electrolyte, binder, a conductive additive and other additives (such as thickener). The cathode 10 preferably includes a cathode current collector 11 that is in contact with the cathode mixture layer 12.

The cathode current collector 11 may be composed of metal foil, metal mesh, or the like. Metal foil is especially preferable. Examples of metal constituting the cathode current collector include stainless steel, nickel, chromium, gold, platinum, aluminum, iron, titanium and zinc. The cathode current collector 11 may be metal foil or a base material which is plated with the metal or on which the metal is deposited. The thickness of the cathode current collector 11 is not specifically limited, and for example, is preferably 0.1 μm to 1 mm, and is more preferably 1 μm to 100 μm.

Any known one as a cathode active material for sulfide solid-state batteries may be employed for the cathode active material contained in the cathode mixture layer 12. Among known active materials, a material showing a nobler charge/discharge potential than an anode active material described later may be the cathode active material. For example, a lithium-containing oxide such as lithium cobaltate, lithium nickelate, Li(Ni,Mn,Co)O₂(Li_{1+α}Ni_{1/3}Mn_{1/3}Co_{1/3}O₂), lithium manganate, spinel lithium composite oxides, lithium titanate, and lithium metal phosphates (LiMPO₄ where M is at least one selected from Fe, Mn, Co and Ni) may be used as the cathode active material. One cathode active material may be used alone, and two or more cathode

active materials may be mixed to be used. The cathode active material may have a coating layer of lithium niobate, lithium titanate, lithium phosphate or the like over its surface. The shape of the cathode active material is not specifically limited, and for example, is preferably in the form of a particle or a thin film. The content of the cathode active material in the cathode mixture layer 12 is not specifically limited, and may be equivalent to the amount of a cathode active material contained in a cathode mixture layer of a conventional sulfide solid-state battery.

Any known one as a solid electrolyte for sulfide solid-state batteries may be employed for the solid electrolyte contained in the cathode mixture layer 12 as an optional constituent. For example, a sulfide solid electrolyte described later is preferably employed. An inorganic solid electrolyte other than the sulfide solid electrolyte may be contained in addition to the sulfide solid electrolyte as long as a desired effect can be brought about. The shape of the solid electrolyte is not specifically limited, and for example, is preferably in the form of a particle. The content of the solid electrolyte in the cathode mixture layer 12 is not specifically and may be equivalent to the amount of a solid electrolyte contained in a cathode mixture layer of a conventional sulfide solid-state battery.

Any one known as a conductive additive employed in a sulfide solid-state battery may be employed for the conductive additive contained in the cathode mixture layer 12 as an optional constituent. For example, a carbon material such as acetylene black (AB), Ketjen black (KB), vapor grown carbon fibers (VGCF), carbon nanatubes (CNT), carbon nanofibers (CNF) and graphite; or a metallic material such as nickel, aluminum and stainless steel may be used. Especially a carbon material is preferable. One conductive additive may be used individually, and two or more conductive additives may be mixed to be used. The shape of the conductive additive is not specifically limited, and for example, is preferably in the form of a particle. The content of the conductive additive in the cathode mixture layer 12 is not specifically limited, and may he equivalent to the amount of a conductive additive contained in a cathode mixture layer of a conventional sulfide solid-state battery.

Any known one as binder employed in a sulfide solid-state battery may be employed for the binder contained in the cathode mixture layer 12 as an optional constituent. For example, at least one selected from styrene-butadiene rubber (SBR), carboxymethyl cellulose (CMC), acrylonitrile-butadiene rubber (ABR), butadiene rubber (BR), butyl rubber (IIR), polyvinylidene fluoride (PVH), polytetrafluoroethylene (PTFE), etc. may be used. The content of the binder in the cathode mixture layer is not specifically limited, and may be equivalent to the amount of binder contained in a cathode mixture layer of a conventional sulfide solid-state battery.

The cathode 10 having the structure described above can be easily produced via a process such as putting and kneading the cathode active material, and the solid electrolyte, the binder and the conductive additive which are optionally contained, etc. in a non-aqueous solvent to obtain a slurry electrode composition, and thereafter applying this electrode composition to a surface of the cathode current collector and drying the applied surface. The cathode can be produced by not only such a wet process but also a dry process. When the cathode mixture layer in the form of a sheet is formed over the surface of the cathode current collector as described above, the thickness of the cathode mixture layer is, for example, preferably 0.1 μm to 1 mm, and more preferably 1 μm to 100 μm.

1.2. Anode 20

The structure of the anode 20 in the sulfide solid-state battery 100 is obvious for the person skilled in the art, and hereinafter one example thereof will be described. The anode 20 usually includes an anode mixture layer 22 that contains an anode active material, and as optional constituents, a solid electrolyte, binder, a conductive additive and other additives (such as thickener). The anode 20 preferably includes an anode current collector 21 that is in contact with the anode mixture layer 22.

The anode current collector 21 may be composed of metal foil, metal mesh or the like. Metal foil is especially preferable. Examples of metal constituting the anode current collector 21 include copper, nickel, iron, titanium, cobalt, zinc and stainless steel. Copper is especially preferable. The anode current collector 21 may be metal foil or a base material which is plated with the metal or on which the metal is deposited. The thickness of the anode current collector 21 is not specifically limited, and for example, is preferably 0.1 μm, and is more preferably 1 μm to 100 μm.

Any known one as an anode active material for sulfide solid-state batteries may be employed for the anode active material contained in the anode mixture layer 22. Among known active materials, a material showing a baser charge/discharge potential than the cathode active material described above may be the anode active material. For example, a silicon-based active material such as Si and Si alloys; a carbon-based active material such as graphite and hard carbon; any oxide-based active material such as lithium titanate; or metal lithium or a lithium alloy may be used as the anode active material. One anode active material may be used alone, and two or more anode active materials may be mixed to be used. The shape of the anode active material is not specifically limited, and for example, is preferably in the form of a particle or a thin film. The content of the anode active material in the anode mixture layer 22 is not specifically limited, and may be equivalent to the amount of an anode active material contained in an anode mixture layer of a conventional sulfide solid-state battery.

Any known one as a solid electrolyte for sulfide solid-state batteries may be employed for the solid electrolyte contained in the anode mixture aver 22 as an optional constituent. For example, a sulfide solid electrolyte described later is preferably employed. An inorganic solid electrolyte other than the sulfide solid electrolyte may be contained in addition to the sulfide solid electrolyte as long as a desired effect can be brought about. The shape of the solid electrolyte is not specifically limited, and for example, is preferably in the form of a particle. The content of the solid electrolyte in the anode mixture layer 22 is not specifically limited, and may be equivalent to the amount of a solid electrolyte contained in an anode mixture layer of a conventional sulfide solid-state battery.

Any one known as a conductive additive employed in a sulfide solid-state battery may be employed for the conductive additive contained in the anode mixture layer 22 as an optional constituent. For example, a carbon material such as acetylene black (AB), Ketjen black (KB), vapor grown carbon fibers (VGCF), carbon nanotubes (CNT), carbon nanofibers (CNF) and graphite or a metallic material such as nickel, aluminum and stainless steel may be used. Especially a carbon material is preferable. One conductive additive may be used individually, and two or more conductive additives may be mixed to be used. The shape of the conductive additive is not specifically limited, and for example, is preferably in the form of a particle. The content of the conductive additive in the anode mixture layer 22 is not specifically limited, and may be equivalent to the amount of a conductive additive contained in an anode mixture layer of a conventional sulfide solid-state battery.

Any known one as binder employed in a sulfide solid-state battery may be employed for the binder contained in the anode mixture layer 22 as an optional constituent. For example, at least one selected from styrene-butadiene rubber (SBR), carboxymethyl cellulose (CMC), acrylonitrile-butadiene rubber (ABR) butadiene rubber (BR), butyl rubber (IIR), polyvinylidene fluoride (PVdF), polytetrafluoroethylene (PTFE), polyimide (PI), etc. may be used. The content of the binder in the anode mixture layer is not specifically limited, and may be equivalent to the amount of binder contained in an anode mixture layer of a conventional sulfide solid-state battery.

The anode 20 having the structure described above can be easily produced via a process such as putting and kneading the anode active material, and the solid electrolyte, the binder and the conductive additive which are optionally contained, etc. into a non-aqueous solvent to obtain a slurry electrode composition, and thereafter applying this electrode composition to a surface of the anode current collector and drying the applied surface. The anode can be produced by not only such a wet process but also a dry process. When the anode mixture layer in the form of a sheet is formed over the surface of the anode current collector as described above, the thickness of the anode mixture layer is, for example, preferably 0.1 μm to 1 mm, and more preferably 1 μm to 100 μm.

1.3. Solid Electrolyte Layer 30

The solid electrolyte layer 30 contains a sulfide solid electrolyte, at least one binder selected from a fluorine-based binder and a rubber-based binder, and ethyl cellulose. The solid electrolyte layer 30 may contain optional constituents other than them as long as the problem can be solved.

Any known sulfide that is employed for a solid electrolyte for sulfide solid-state batteries may be employed for the sulfide solid electrolyte. For example, a solid electrolyte containing Li, P and S as constituent elements may be used. Specific examples include Li₂S—P₂S₅, Li₂S—SiS₂, LiI—Li₂S—SiS₂, LiI—Si₂S—P₂S₅, LiI—LiBr—Li₂S—P₂S₅, LiI—Li₂S—P₂S₅, LiI—Li₂O—Li₂S—P₂S₅, LiI—Li₂S—P₂O₅, LiI—Li₃PO₄—P₂S₅ and Li₂S—P₂S₅—GeS₂. A sulfide solid electrolyte containing Li₂S—P₂S₅ among them is especially more preferable. One sulfide solid electrolyte may be used individually, and two or more sulfide solid electrolytes may be mixed to be used. The shape of the sulfide solid electrolyte is not specifically limited, and for example, may be in the form of a particle. The content of the sulfide solid electrolyte in the solid electrolyte layer 30 is not specifically limited, and may be equivalent to the amount of a sulfide solid electrolyte contained in a solid electrolyte layer of a conventional sulfide solid-state battery.

The solid electrolyte layer 30 contains at least one of a fluorine-based binder and a rubber-based binder. Any known fluorine-based binder that is employed for binder for sulfide solid-state batteries may be employed for the fluorine-based binder. Examples thereof include polyvinylidene fluoride (PVdF) and polytetrafluoroethylene (PTFE). Among them, PVdF is preferable. Any known rubber-based binder that is employed for binder for sulfide solid-state batteries may be employed for the rubber-based binder. Examples thereof include butyl rubber (IIR), butadiene rubber (BR), styrene-butadiene rubber (SBR) and acrylonitrile-butadiene rubber (ABR). Among them, IIR or BR is preferable, and IIR is especially preferable. In the solid electrolyte layer 30, the fluorine-based binder and the rubber-based binder may be used in combination. The content of the binder in the solid electrolyte layer 30 is not specifically limited, and may be equivalent to the amount of binder contained in a solid electrolyte layer of a conventional sulfide solid-state battery. In view of further improving crack resistance and ion conductivity, the content of the binder in the solid electrolyte layer 30 is preferably 0.5 vol % to 10 vol %. The upper limit thereof is more preferably no more than 5 vol %.

The binder finely and uniformly disperses all over the solid electrolyte layer 30 due to action of ethyl cellulose described later, which improves crack resistance and ion conductivity of the solid electrolyte layer 30. The state of dispersing the binder in the solid electrolyte layer 30 can be easily confirmed by, for example, obtaining a cross-sectional image of the solid electrolyte layer 30 by means of a SEM or the like, and acquiring elemental mapping of this image. Specifically, when the fluorine-based binder is contained as the binder, the average value of circle equivalent diameters of the fluorine-based binder which is obtained from the cross-sectional image of the solid electrolyte layer 30 is preferably smaller than 0.2 μm, more preferably no more than 0.15 μm, further preferably no more than 0.11 μm, and especially preferably no more than 0.10 μm. “Average value of circle equivalent diameters” in this application means the so-called average value in the 95% confidence interval. Procedures for obtaining the average value of circle equivalent diameters of the fluorine-based binder from the cross-sectional image of the solid electrolyte layer will be described in detail in Examples later.

According to findings of this inventor, when only ethyl cellulose but no binder is contained in the solid electrolyte layer 30 along with the sulfide solid electrolyte, sulfide solid electrolytes cannot be bound together, and the solid electrolyte layer 30 cannot be densified. That is, in the solid electrolyte layer 30, ethyl cellulose is hard to function as binder, but functions as an additive for improving dispersiveness of the fluorine-based binder and/or the rubber-based hinder. The molecular weight of ethyl cellulose is not specifically limited. Any commercially available ethyl cellulose may be employed. Ethyl cellulose preferably dissolves in a non-aqueous solvent described later to function as increasing viscosity. The content of ethyl cellulose in the solid electrolyte layer 30 is not specifically limited, and may be properly adjusted according to the amount of the binder. In view of further improving crack resistance and ion conductivity, in the solid electrolyte layer 30, the volume of ethyl cellulose is preferably the same as or smaller than that of the binder. From the same viewpoint, the solid electrolyte layer 30 preferably contains 0.1 vol % to 5 vol % of ethyl cellulose. The upper limit of this content is more preferably no more than 1 vol %.

The solid electrolyte layer 30 having the structure described above can be easily produced via a process such as putting and kneading the sulfide solid electrolyte, the binder, and ethyl cellulose in a non-aqueous solvent to obtain a slurry electrolyte composition, and thereafter applying this electrolyte composition to a surface of a base material, or (a) surface(s) of the cathode mixture layer 12 and/or the anode mixture layer 22 and drying the applied surface(s). When the solid electrolyte layer in the form of a sheet is formed as described above, the thickness of the solid electrolyte layer is, for example, preferably 0.1 μm to 1 mm, and more preferably 1 μm to 100 μm.

1.4. Other Members

Needless to say, the sulfide solid-state battery 100 may include (a) necessary terminals, battery case, etc, in addition to the cathode 10, the anode 20 and the solid electrolyte layer 30. These members are publicly known, and detailed description thereof is omitted here.

2. Method for Producing Sulfide Solid-State Battery

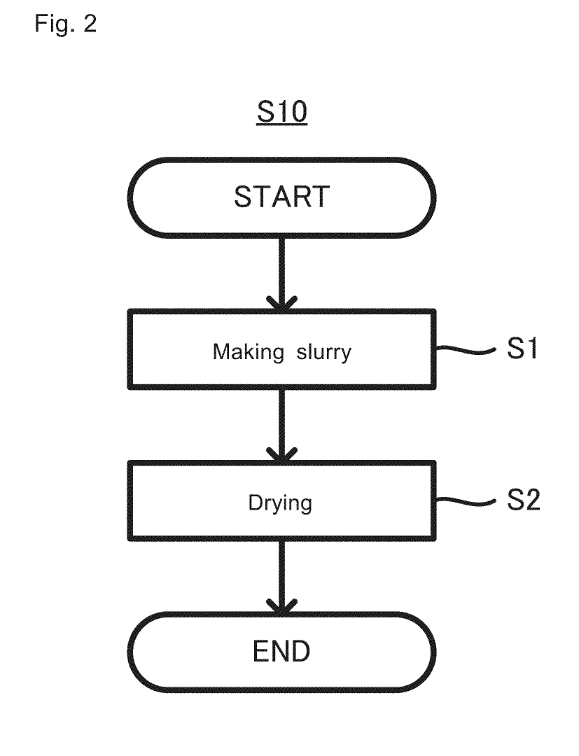

When the sulfide solid-state battery 100 is produced, the solid electrolyte layer 30 is preferably produced via a wet process using a non-aqueous solvent. That is, as shown in FIG. 2, preferably, a method for producing the sulfide solid-state battery 100 S10 includes a step S1 of mixing at least the sulfide solid electrolyte, at least one binder selected from the fluorine-based binder and the rubber-based binder, ethyl cellulose and a non-aqueous solvent to obtain a slurry, and a step S2 of drying the slurry to obtain the solid electrolyte layer.

2.1. Step S1

In the step S1, at least the sulfide solid electrolyte, at least one binder selected from the fluorine-based binder and the rubber-based binder, ethyl cellulose and a non-aqueous solvent are mixed to obtain a slurry. The slurry may contain optional constituents other than them as long as the problem can be solved.

Any non-aqueous solvent may be used as long as not reacting with the sulfide solid electrolyte and as long as the binder and ethyl cellulose are soluble therein. In the slurry, the binder and ethyl cellulose are preferably dissolved. However, all the binder and ethyl cellulose do not need to be dissolved. A non-aqueous solvent in which the binder is not dissolved but swells may be used. A polar or nonpolar solvent, or a combination thereof may be used as the non-aqueous solvent without any specific limitation. Examples of a nonpolar solvent include heptane, toluene, xylem and mesitylene. Examples of a polar solvent include ethanol, N-methylpyrrolidone, butyl acetate and butyl butyrate. Among them, mesitylene or butyl butyrate is preferable, One non-aqueous solvent may be used alone, and two or more non-aqueous solvents may be mixed to be used.

The concentration of the solid content (constituents that do not dissolve in the non-aqueous solvent, such as the sulfide solid electrolyte) in the slurry is not specifically limited. In view of coating properties etc., the slurry preferably contains 15 vol % to 30 vol % of the solid content.

2.2. Step S2

In the step S2, the slurry is dried to obtain the solid electrolyte layer 30. For example, as described above, the slurry is applied onto a surface of a base material, or (a) surface(s) of the cathode mixture layer 12 and/or the anode mixture layer 22 to be dried, which makes it possible to form the solid electrolyte layer 30. In this case, a means to apply the slurry is not specifically limited. Any application means such as a blade may be used. A drying means is not specifically limited as well. Only air drying may be carried out, and drying by means of any heating means such as a heater may be carried out.

2.3. Other Steps

Features of the method for producing the sulfide solid-state battery 100 are in the steps S1 and S2. Other steps may be the same as in a conventional method. For example, the sulfide solid-state battery 100 can be produced via the steps of producing the cathode 10 and the anode 20, layering the cathode 10, the solid electrolyte layer 30 and the anode 20 to make a laminate, and storing the laminate into a battery case, in addition to the steps S1 and S2.

3. Slurry for Sulfide Solid-State Battery

As described above, when the sulfide solid-state battery 100 of this disclosure is produced, a slurry is preferably used. That is, the technique of this disclosure also has an aspect of “slurry for the sulfide solid-state battery”, specifically, a slurry for the sulfide solid-state battery, the slurry containing the sulfide solid electrolyte, at least one binder selected from the fluorine-based binder and the rubber-based binder, ethyl cellulose and the non-aqueous solvent. Preferred constituents of the slurry are as described above, and detailed description thereof is omitted here.

4. Addition

The technique of this disclose is believed to have a certain effect even when applied to the cathode mixture layer 12 and/or the anode mixture layer 22. That is, in the cathode mixture layer 12 and/or the anode mixture layer 22, it is believed that dispersiveness of the binder can be improved, and crack resistance and ion conductivity of the mixture layer can be improved by containing ethyl cellulose together with the binder.

As described above, the slurry for the sulfide solid-state battery of the present disclosure may be used as well when the cathode mixture layer 12 and/or the anode mixture layer 22 is/are formed while preferably used especially when the solid electrolyte layer 30 of the sulfide solid-state battery 100 is formed. That is, the slurry for the sulfide solid-state battery of this disclosure may further contain the cathode active material or the anode active material in addition to the sulfide solid electrolyte, at least one binder selected from the fluorine-based binder and the rubber-based binder, ethyl cellulose and the non-aqueous solvent. A preferred concentration of the solid content etc. of the shiny in this case is the same as the above.

### EXAMPLES

1. Forming Solid Electrolyte Layer

A sulfide solid electrolyte (main constituent: Li₂S—P₂S₅), polyvinylidene fluoride (PVdF), ethyl cellulose (EC) and butyl butyrate which had the composition shown in the following Table 1 were put into a plastic container of 10 mL, processed by means of an ultrasonic homogenizer until the whole was uniform, and stirred by means of a shaker, to obtain a slurry. Stainless steel foil having 10 μm in thickness was coated with the obtained slurry by means of a blade having 225 μm in gap. After air-dried, a coating film was dried on a hot plate at 100° C. for 30 minutes, to fully remove butyl butyrate. Thereafter pressing was carried out at 60 kN/cm² in contact pressure for 3 minutes to carry out densification, to obtain a solid electrolyte layer.

TABLE 1

| | Comp. Ex. 1 | Comp. Ex. 2 | Comp. Ex. 3 | Comp. Ex. 4 | Ex. 1 | Ex. 2 | Ex. 3 | Ex. 4 |
|---|---|---|---|---|---|---|---|---|
| Amount of sulfide | 1200 | 1200 | 1200 | 1200 | 1200 | 1200 | 1200 | 1200 |
| solid electrolyte (mg) | | | | | | | | |
| Amount of PVdF (mg) | 31 | 52 | 86 | 0 | 52 | 52 | 52 | 55 |
| Amount of EC (mg) | 0 | 0 | 0 | 68 | 0.66 | 3.3 | 6.6 | 34 |
| Percentage of PVdF in | 3 | 5 | 8 | 0 | 5 | 5 | 5 | 5 |
| solid electrolyte layer | | | | | | | | |
| (vol %) | | | | | | | | |
| Percentage of EC in | 0 | 0 | 0 | 10 | 0.1 | 0.5 | 1 | 5 |
| solid electrolyte layer | | | | | | | | |
| (vol %) | | | | | | | | |

2. Evaluation of Solid Electrolyte Layer

2.1. Measurement of Ion Conductivity

The ion conductivity of the solid electrolyte layer was measured from the I-V characteristic which was measured by applying currents of ±10 μA, ±25 μA and ±100 μA for 15 minutes each under the condition where both sides of the solid electrolyte layer were Li electrodes.

2.2. Evaluation of Minimum Bend Radius (Crack Resistance)

After punched out to have 11.28 mm in diameter, solid electrolyte layers were closely adhered to cylindrical surfaces of cylinders of stainless steel each having 21.5 mm, 11 mm, 8 mm, 6.5 mm, 5 mm, 4.4 mm and 3 mm in thickness. A diameter one size larger than that which led to cracking was regarded as the minimum bend radius.

2.3. Tissue Observation

After a cross section of the solid electrolyte was made by means of a cross section polisher, the cross section was observed by means of a SEM (manufactured by Hitachi, Ltd.), and a mapping image of fluorine was obtained by EDX (manufactured by Bruker), to evaluate the state of dispersing PVdF. Here, a magnification was such that dozens to several hundreds of particles of the binder were confirmed in the image (5000 magnifications in Examples), and the image was such that the other portions than the solid electrolyte layer were not shown therein.

2.4. Evaluation of Dispersiveness of Binder Contained in Solid Electrolyte Layer

In order to quantify the state of dispersing the binder contained in the solid electrolyte layer, analysis was carried out using image analysis software, WinROOF2013 (registered trademark) and Microsoft Excel (registered trademark) under the following procedures (1) to (5), to calculate the average value of circle equivalent diameters of the binder contained in the solid electrolyte layer.

(1) Three F mapping images (format: JPEG, 600×450 dots each) per sample were obtained, and were monochromatized, underwent grayscale inversion and contrast enhancement processing (50%), and were blurred (3×3 dots each).

(2) Binarization was carried out so that the total area of the F-presence zones corresponded to PVdF contained in the solid electrolyte layer (vol %) (for example, in Examples 1 to 3, so that the total area of the F-presence zones was 5% of the whole of each image).

(3) The circle equivalent diameters in all the F-presence zones in three images per sample were obtained to calculate the standard deviation of the circle equivalent diameters. The calculated value was defined as “standard deviation of the population”.

(4) The 95% confidence interval of the circle equivalent diameters in the F-presence zones was calculated per image based on the standard deviation of the population and the number of F-presence zones, to calculate the average value of the circle equivalent diameters of the F-presence zones within this interval.

(5) The weight average value based on the number of the F-presence zones in each image was obtained from e average values of the circle equivalent diameters obtained from three images per sample. This value was used as “average value of circle equivalent diameters”. For example, the number of the F-presence zones was N1 and the average value of circle equivalent diameters was D1 in the first image of a sample, the number of the F-presence zones was N2 and the average value of circle equivalent diameters was D2 in the second image thereof, and the number of the F-presence zones was N3 and the average value of circle equivalent diameters was D3 in the third image thereof, “average value of circle equivalent diameters” of the binder in the whole of the sample was:

(average value of circle equivalent diameters)=(N1×D1+N2×D2+N3×D3)/(N1+N2+N3)

3. Evaluation Results

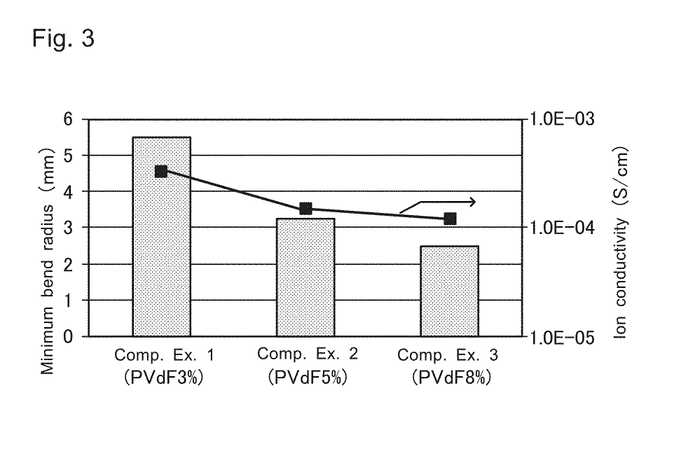

FIG. 3 shows the minimum bend radii and ion conductivity when ethyl cellulose was not added into the solid electrolyte layer (Comparative Examples 1 to 3). As shown in FIG. 3, it is found that a larger amount of adding PVdF led to a smaller minimum bend radius, which improved crack resistance while ion conductivity lowered. When only ethyl cellulose was added into but no PVdF was contained in the solid electrolyte layer (Comparative Example 4), it was impossible to bind sulfide solid electrolytes together, and to density the solid electrolyte layer.

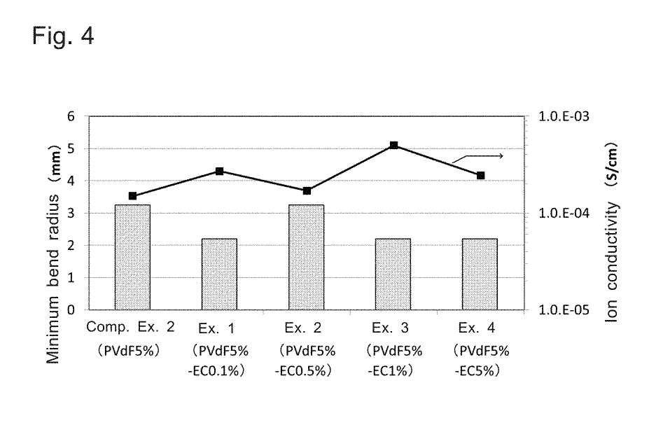

FIG. 4 shows the minimum bend radii and ion conductivity when ethyl cellulose was added into the solid electrolyte layer together PVdF (5 vol %) (Examples 1 to 4). As shown in FIG. 4, it is found that adding ethyl cellulose into the solid electrolyte layer along with PVdF improved both crack resistance and ion conductivity.

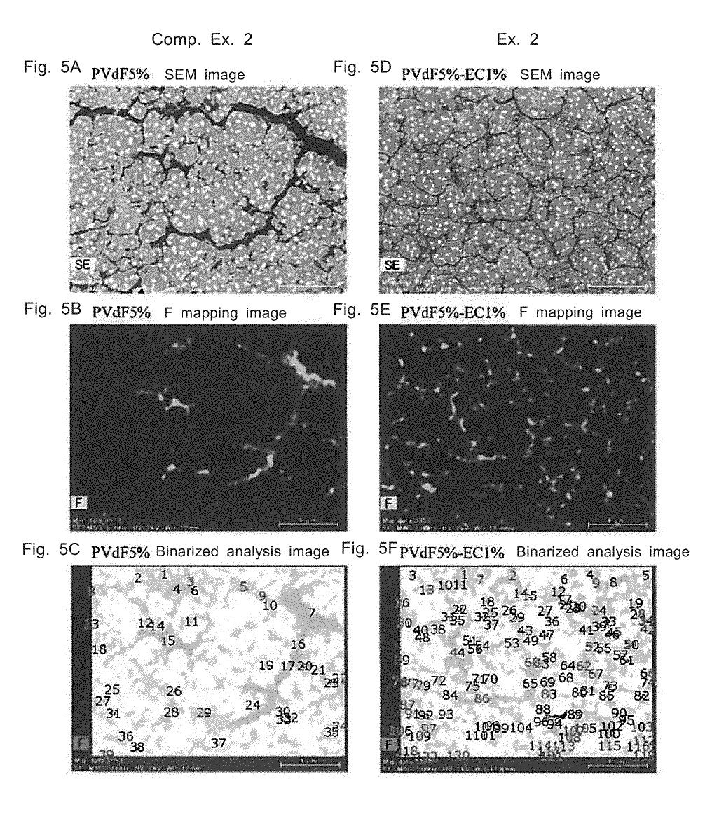

FIGS. 5A to 5F show cross-sectional SEM images, F mapping images and binarized analysis images of the solid electrolyte layers according to Comparative Example 2 and Example 2. FIGS. 5A to 5C correspond to Comparative Example 2, and FIGS. 5D to 5F correspond to Example 2. As shown in FIGS. 5A to 5F, it is found that PVdF more finely and more uniformly dispersed over the solid electrolyte layer of Example 2 than that of Comparative Example 2.

The following Table 2 shows the average values of circle equivalent diameters of the binders contained in the solid electrolyte layers according to Comparative Example 2 and Examples 2 to 4. As apparent from the results shown in Table 2, it is found that adding ethyl cellulose together with PVdF into the solid electrolyte layer made the binder micronized, which improved dispersiveness. In Examples 1 to 4, it is believed that the binder finely and uniformly dispersed all over the solid electrolyte layer as described above, which improved both crack resistance and ion conductivity.

TABLE 2

| | Comp. | | | |
|---|---|---|---|---|
| | Ex. 2 | Ex. 2 | Ex. 3 | Ex. 4 |
| Percentage of PVdF in solid electrolyte | 5 | 5 | 5 | 5 |
| layer (vol %) | | | | |
| Percentage of EC in solid electrolyte | 0 | 0.5 | 1 | 5 |
| layer (vol %) | | | | |
| Average value of circle equivalent | 0.20 | 0.10 | 0.10 | 0.11 |
| diameters (μm) | | | | |

Examples 1 to 3 showed PVdF used as a fluorine-based binder. Examples of using a rubber-based binder as the binder will be shown below.

4.Making Solid Electrolyte Layer

A sulfide solid electrolyte (main constituent: Li₂S—P₂S₅), butyl rubber (IIR), ethyl cellulose (EC) and butyl butyrate which had the composition shown in the following Table 3 were put into a plastic container of 10 mL, processed by means of an ultrasonic homogenizer until the whole was uniform, and stirred by means of a shaker, to obtain a slurry. Stainless steel foil having 10 μm in thickness was coated with the obtained slurry by means of a blade having 225 μm in gap. After air-dried, a coating film was dried on a hot plate at 100° C. for 30 minutes, to fully remove butyl butyrate. Thereafter pressing was carried out at 60 kN/cm² in contact pressure for 3 minutes to carry out densification, to obtain a solid electrolyte layer.

TABLE 3

| | Comp. | |
|---|---|---|
| | Ex. 5 | Ex. 5 |
| Amount of sulfide solid electrolyte (mg) | 1200 | 1200 |
| Amount of IIR (mg) | 28.6 | 30.2 |
| Amount of EC (mg) | 0 | 21.5 |
| Percentage of IIR in solid electrolyte layer (vol %) | 5 | 5 |
| Percentage of EC in solid electrolyte layer (vol %) | 0 | 5 |

5. Evaluation of Solid Electrolyte Layer

Ion conductivity and the minimum bend radius of the solid electrolyte layer were measured in the same manner as in the Example 1 etc.

6. Evaluation Results

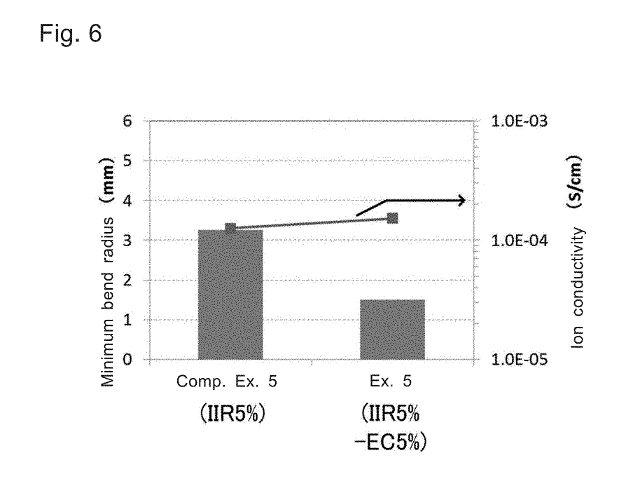

FIG. 6 shows the minimum bend radii and ion conductivity of the solid electrolyte layers according to Example 5 and Comparative Example 5. As shown in FIG. 6, it is found that both crack resistance and ion conductivity were more improved when ethyl cellulose was added into the solid electrolyte layer along with IIR (Example 5) than when ethyl cellulose was not added (Comparative Example 5). That is, it is found that the effect of ethyl cellulose is excreted not only when a fluorine-based binder is used but also when a rubber-based binder is used.

7. Addition

Examples showed PVdF used as a typical fluorine-based binder, and IIR used as a typical rubber-based binder. A fluorine-based binder and a rubber-based binder are not limited to them. The effect of ethyl cellulose is also excreted on fluorine-based binders other than PVdF, and rubber-based binders other than IIR.

Ethyl cellulose can function as a thickener. From this viewpoint, it was confirmed by an experiment whether the same effect was exerted even when a thickener other than ethyl cellulose was used to form the solid electrolyte layer. As a result, it was confirmed that a thickener other than ethyl cellulose did not contribute to improvement of crack resistance and ion conductivity of the solid electrolyte layer. That is, it can be said that crack resistance and ion conductivity of the solid electrolyte layer are specifically improved when the sulfide solid electrolyte, at least one binder selected from a fluorine-based binder and a rubber-based binder, and ethyl cellulose are combined.

### INDUSTRIAL APPLICABILITY

The sulfide solid-state battery of this disclosure may be preferably used in a wide range of power sources including a small-sized power source for portable devices, and an onboard large-sized power source.

### REFERENCE SIGNS LIST

10 cathode
11 cathode current collector
12 cathode mixture layer

20 anode
21 anode current collector
22 anode mixture layer

30 solid electrolyte layer

100 sulfide solid-state battery

What is claimed is:

1. A sulfide solid-state battery comprising:
a cathode,
an anode, and
a solid electrolyte layer provided between the cathode and the anode, the solid electrolyte layer containing a sulfide solid electrolyte, at least one binder selected from a fluorine-based binder and a rubber-based binder, and ethyl cellulose.

2. The sulfide solid-state battery according to claim 1, wherein
in the solid electrolyte layer, a volume of the ethyl cellulose is the same as or smaller than a volume of the binder.

3. The sulfide solid-state battery according to claim 1, wherein the solid electrolyte layer contains 0.1 vol % to 5 vol % of the ethyl cellulose.

4. The sulfide solid-state battery according to claim 3, wherein the solid electrolyte layer contains 0.1 vol % to 1 vol % of the ethyl cellulose.

5. The sulfide solid-state battery according to claim 1, wherein
the solid electrolyte layer contains the fluorine-based binder as the binder, and
an average value of circle equivalent diameters of the fluorine-based binder is smaller than 0.2 μm, the average value being obtained by a cross-sectional image of the solid electrolyte layer.
